(19) United States
(12) Patent Application Publication
(10) Pub. No.: US 2012/0275638 A1
(43) Pub. Date: Nov. 1, 2012

(54) Sandwich-Type Woofer with Two Sound Wave Propagation Directions and a Magnetic-Looped Device Thereof

(76) Inventor: Tzu-Chung Chang, Kaohsiung City (TW)

(21) Appl. No.: 13/190,541

(22) Filed: Jul. 26, 2011

Related U.S. Application Data
(63) Continuation-in-part of application No. 13/093,916, filed on Apr. 26, 2011.

(51) Int. Cl. H04R 1/00

(52) U.S. Cl. 381/396

(57) ABSTRACT

A sandwich-type woofer with two sound wave propagation directions includes a first magnetic-conducting plate unit, a second magnetic-conducting plate unit, a magnet unit, a coil frame, a first vibrating unit, a second vibrating unit, a first coil and a second coil. The magnet unit is sandwiched between the first and second magnetic-conducting plate units. The coil frame extends through the first and second magnetic-conducting plate units and the magnet unit, and has first and second ends. The first vibrating unit is disposed at the first end of the coil frame and the second vibrating unit is disposed at the second end of the coil frame. The first coil is arranged on a portion of the coil frame corresponding to the first magnetic-conducting plate unit and the second coil is arranged on another portion of the coil frame corresponding to the second magnetic-conducting plate unit.

### BACKGROUND OF THE INVENTION

1. Field of the Invention

The present invention generally relates to a sandwich-type woofer with two sound wave propagation directions and a magnetic-looped device thereof and, more particularly, to a sandwich-type woofer with two sound wave propagation directions capable of generating two sounds at a same point, as well as a magnetic-looped device thereof.

2. Description of the Related Art

Referring to FIG. 1, a conventional woofer 9 includes a bottom plate 91, a permanent magnet 92, a magnetic-conducting top plate 93, a frame 94, a coil 95, a spring 96, a vibrating plate 97 and a dustproof cap 98. The permanent magnet 92 provides magnetic fields required for driving the coil 95. The permanent magnet 92, magnetic-conducting top plate 93 and coil 95 form a driving assembly that converts electrical energy into mechanical energy, so that the mechanical energy can drive the air to emit sound waves.

However, the sound waves emitted by the conventional woofer 9 do not have a desired magnitude due to limited magnetic energy of the permanent magnet 92. In addition, the radiated sound waves also have larger distortion. Thus, the conventional woofer 9 can't generate good-quality sounds.

In light of the problems, it is desired to improve the conventional woofer 9.

### SUMMARY OF THE INVENTION

It is therefore the primary objective of this invention to provide a sandwich-type woofer with two sound wave propagation directions capable of generating two sounds at a same point, thus amplifying the magnitude of the sound waves generated thereby.

It is another objective of this invention to provide a magnetic-looped device of a sandwich-type woofer with two sound wave propagation directions for driving upper and lower vibrating units of the woofer, thereby radiating sound waves in two directions.

The invention discloses a sandwich-type woofer with two sound wave propagation directions. The sandwich-type woofer includes a first magnetic-conducting plate unit, a second magnetic-conducting plate unit, a magnet unit, a coil frame, a first vibrating unit, a second vibrating unit, a first coil and a second coil. The magnet unit is sandwiched between the first and second magnetic-conducting plate units. The coil frame extends through the first and second magnetic-conducting plate units and the magnet unit, and has first and second ends. The first vibrating unit is disposed at the first end of the coil frame and the second vibrating unit is disposed at the second end of the coil frame. The first coil is arranged on a portion of the coil frame corresponding to the first magnetic-conducting plate unit, and the second coil is arranged on another portion of the coil frame corresponding to the second magnetic-conducting plate unit.

Furthermore, the invention discloses a magnetic-looped device of a sandwich-type woofer with two sound wave propagation directions, which comprises a first magnetic-conducting plate unit, a second magnetic-conducting plate unit, a magnet unit, a coil frame, a first coil and a second coil. The magnet unit is sandwiched between the first and second magnetic-conducting plate units. The coil frame extends through the first and second magnetic-conducting plate units and the magnet unit. The first coil is arranged on a portion of the coil frame corresponding to the first magnetic-conducting plate unit, and the second coil is arranged on another portion of the coil frame corresponding to the second magnetic-conducting plate unit.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a conventional woofer.

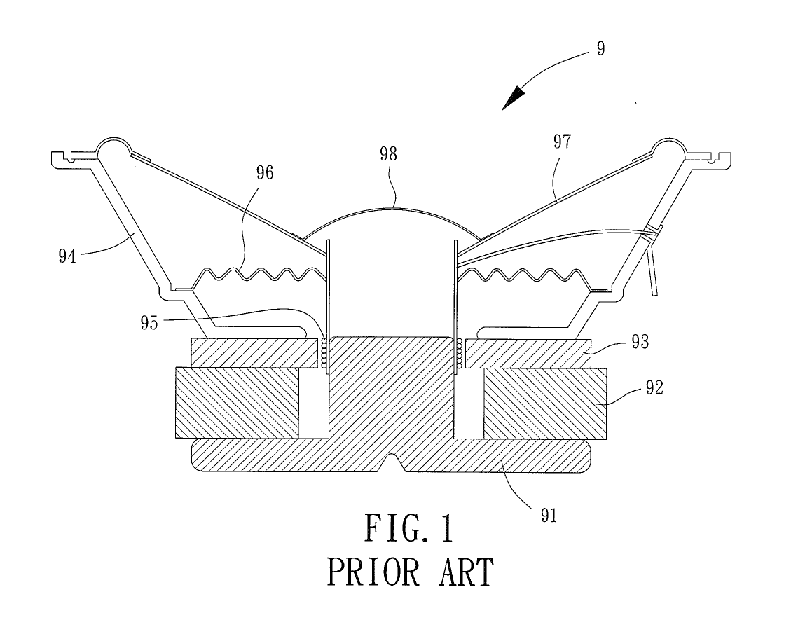

FIG. 2 shows a sandwich-type woofer with two sound wave propagation directions according to a preferred embodiment of the invention.

FIG. 3 shows a magnetic-looped device of the sandwich-type woofer according to the preferred embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

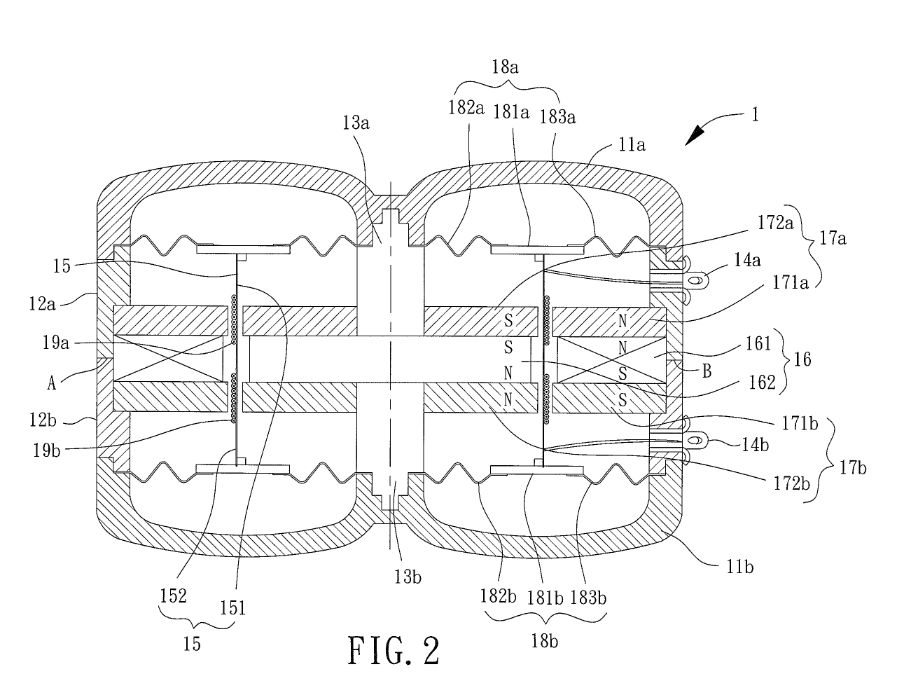

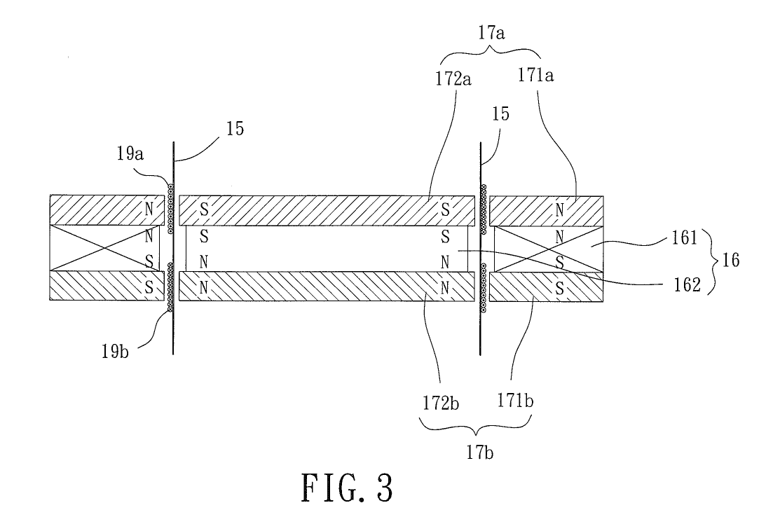

Referring to FIG. 2, a sandwich-type woofer 1 with two sound wave propagation directions includes an upper frame 11a, a lower frame 11b, an upper coupling member 12a, a lower coupling member 12b, an upper supporting pole 13a, a lower supporting pole 13b, a positive electrode 14a, a negative electrode 14b, a coil frame 15, a magnet unit 16, an upper magnetic-conducting plate unit 17a (first magnetic-conducting plate unit), a lower magnetic-conducting plate unit 17b (second magnetic-conducting plate unit), an upper vibrating unit 18a (first vibrating unit), a lower vibrating unit 18b (second vibrating unit), a first coil 19a and a second coil 19b. Referring to FIG. 3, the coil frame 15, magnet unit 16, upper magnetic-conducting plate unit 17a, lower magnetic-conducting plate unit 17b, first coil 19a and second coil 19b may jointly form a magnetic-looped device.

Both the upper frame 11a and the lower frame 11b are in the form of a bowl with eight radially-spaced twigs extending outwards radially from a center of the bowl. The sound waves can radiate through the radially-spaced twigs. The magnet unit 16 is sandwiched between the upper magnetic-conducting plate unit 17a and the lower magnetic-conducting plate unit 17b. The coil frame 15 extends through the upper magnetic-conducting plate unit 17a, lower magnetic-conducting plate unit 17b and magnet unit 16 and has a first end 151 and a second end 152. The upper vibrating unit 18a is disposed at the first end 151 of the coil frame 15 and the lower vibrating unit 18b is disposed at the second end 152 of the coil frame 15. The first coil 19a is an enameled wire wound around a portion of the coil frame 15 corresponding to the upper magnetic-conducting plate unit 17a, and the second coil 19b is the enameled wire wound around another portion of the coil frame 15 corresponding to the lower magnetic-conducting plate unit 17b. In the embodiment, both the upper vibrating unit 18a and the lower vibrating unit 18b may consist of a single spring. Besides, the magnetic-looped device of the invention can generate magnetic fields in two directions to drive the upper vibrating unit 18a and the lower vibrating unit 18b, so as to generate sound waves in two directions.

In the previous embodiment, both the upper vibrating unit 18a and the lower vibrating unit 18b of the sandwich-type woofer 1 may be modified to include two symmetric springs rather than just one single spring. In this embodiment, the magnet unit 16 includes an outer magnet 161 (first magnet) and an inner magnet 162 (second magnet). The upper magnetic-conducting plate unit 17a includes an upper outer magnetic-conducting plate 171a (first magnetic-conducting plate) and an upper inner magnetic-conducting plate 172a (second magnetic-conducting plate), and the lower magnetic-conducting plate unit 17b includes a lower outer magnetic-conducting plate 171b (third magnetic-conducting plate) and a lower inner magnetic-conducting plate 172b (fourth magnetic-conducting plate). The upper vibrating unit 18a includes an upper vibrating board 181a (first vibrating board), an upper inner spring (first spring) 182a and an upper outer spring 183a (second spring). The lower vibrating unit 18b includes a lower vibrating board 181b (second vibrating board), a lower inner spring 182b (third spring) and a lower outer spring 183b (fourth spring).

The upper frame 11a is connected to one end of the upper coupling member 12a via glue. The upper coupling member 12a is connected to the lower coupling member 12b via glue. The upper coupling member 12a and the lower coupling member 12b are connected at nodes A and B as shown in FIG. 2. The coil frame 15 is connected between the upper vibrating board 181a and the lower vibrating board 181b and disposed in a gap between the outer magnet 161 and the inner magnet 162. The outer magnet 161 is sandwiched between the upper outer magnetic-conducting plate 171a and the lower outer magnetic-conducting plate 171b. The outer magnet 161, upper outer magnetic-conducting plate 171a, lower outer magnetic-conducting plate 171b, upper outer spring 183a and lower outer spring 183b are located at one side of the coil frame 15. The inner magnet 162 is sandwiched between the upper inner magnetic-conducting plate 172a and the lower inner magnetic-conducting plate 172b. The inner magnet 162, upper inner magnetic-conducting plate 172a, lower inner magnetic-conducting plate 172b, upper inner spring 182a and lower inner spring 182b are located at the other side of the coil frame 15. The upper inner magnetic-conducting plate 172a, inner magnet 162 and lower inner magnetic-conducting plate 172b are connected to the upper supporting pole 13a and the lower supporting pole 13b via glue. The upper vibrating board 181a is disposed at the first end 151 of the coil frame 15 and connected to the upper frame 11a. The upper vibrating board 181a has an inner edge connected to the upper supporting pole 13a via the upper inner spring 182a, as well as an outer edge connected to the upper frame 11a via the upper outer spring 183a. The lower vibrating board 181b is disposed at the second end 152 of the coil frame 15 and connected to the lower frame 11b. The lower vibrating board 181b has an inner edge connected to the lower supporting pole 13b via the lower inner spring 182b, as well as an outer edge connected to the lower frame 11b via the lower outer spring 183b. By this arrangement, the sandwich-type woofer 1 with two symmetric vibrating units (upper and lower vibrating units) and two symmetric springs (inner and outer springs) is formed.

Since the sandwich-type woofer of the invention is designed with two symmetric vibrating units, the sandwich-type woofer is able to simultaneously generate sound waves that travel in two directions. Furthermore, since the sandwich-type woofer of the invention is designed with two magnetic paths, the sound waves produced by the sandwich-type woofer may have larger magnitude. Moreover, as can be seen in the second embodiment, the sandwich-type woofer can include two symmetric springs. Thus, the vibration balance of the upper and lower vibrating units will be better, thereby generating good-quality sounds.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A sandwich-type woofer with two sound wave propagation directions, comprising:
a first magnetic-conducting plate unit;
a second magnetic-conducting plate unit;
a magnet unit sandwiched between the first and second magnetic-conducting plate units;
a coil frame extending through the first magnetic-conducting plate unit, the magnet unit and the second magnetic-conducting plate unit, and having a first end and a second end;
a first vibrating unit disposed at the first end of the coil frame;
a second vibrating unit disposed at the second end of the coil frame;
a first coil arranged on a portion of the coil frame corresponding to the first magnetic-conducting plate unit; and
a second coil arranged on another portion of the coil frame corresponding to the second magnetic-conducting plate unit.

2. The sandwich-type woofer with two sound wave propagation directions as claimed in claim 1, wherein:
the first magnetic-conducting plate unit includes a first magnetic-conducting plate and a second magnetic-conducting plate,
the second magnetic-conducting plate unit includes a third magnetic-conducting plate and a fourth magnetic-conducting plate,
the first vibrating unit includes a first vibrating board, a first spring and a second spring, wherein the first vibrating board is connected to the first end of the coil frame,
the second vibrating unit includes a second vibrating board, a third spring and a fourth spring, wherein the second vibrating board is connected to the second end of the coil frame,
the magnet unit includes a first magnet and a second magnet, the first magnet is sandwiched between the first and third magnetic-conducting plates, wherein the first magnet, the first and third magnetic-conducting plates, and the second and fourth springs are located at one side of the coil frame, the second magnet is sandwiched between the second and fourth magnetic-conducting plates, wherein the second magnet, the second and fourth magnetic-conducting plates, and the first and third springs are located at the other side of the coil frame.

3. The sandwich-type woofer with two sound wave propagation directions as claimed in claim 1, wherein both the first and second vibrating units include a single spring.

4. A magnetic-looped device of a sandwich-type woofer with two sound wave propagation directions, comprising:
a first magnetic-conducting plate unit;
a second magnetic-conducting plate unit;
a magnet unit sandwiched between the first and second magnetic-conducting plate units;
a coil frame extending through the first magnetic-conducting plate unit, the magnet unit and the second magnetic-conducting plate unit;
a first coil arranged on a portion of the coil frame corresponding to the first magnetic-conducting plate unit; and
a second coil arranged on another portion of the coil frame corresponding to the second magnetic-conducting plate unit.
